(19) United States
(12) Patent Application Publication
(10) Pub. No.: US 2026/0122291 A1
(43) Pub. Date: Apr. 30, 2026

(54) LOW-LATENCY LIVE AUDIO STREAMING SYSTEM

(71) Applicant: Abrianna T. GALLO, Columbus, OH (US)

(72) Inventor: Abrianna T. GALLO, Columbus, OH (US)

(21) Appl. No.: 19/373,545

(22) Filed: Oct. 29, 2025

Related U.S. Application Data
(60) Provisional application No. 63/713,360, filed on Oct. 29, 2024.

(51) Int. Cl. H04N 21/2187; H04N 21/258

(52) U.S. Cl. CPC H04N 21/2187; H04N 21/25816

(57) ABSTRACT

A method for enabling streaming of audio is disclosed. The method includes: establishing a live streaming session, via a streaming service API, the live streaming session streaming audio data from a first user captured via a first user device; receiving a session identifier generated by the streaming service API, the session identifier associated with the live streaming session; generating a join code associated with the session identifier; verifying the join code received from a second user via a second user device; providing the session identifier to the second user device; and transmitting the live streaming session to the second user device in response to receiving the session identifier.

### CROSS REFERENCE TO RELATED APPLICATIONS

This U.S. Non-Provisional patent application claims priority to U.S. Provisional Patent Application Ser. No. 63/713,360 filed Oct. 29, 2024, the contents of which are incorporated herein by reference in its entirety.

### TECHNICAL FIELD

The present disclosure relates to real-time audio streaming systems.

### BACKGROUND

Real-time audio streaming systems typically rely on centralized architectures to handle session management, data synchronization, and access control. This setup can be less flexible, limit scalability, and be more complicated for user to access. A more dynamic and scalable solution is needed.

### SUMMARY

This disclosure relates generally to a low-latency live audio streaming system.

An aspect of the disclosed embodiments includes a method for enabling streaming of audio. The method includes: establishing a live streaming session, via a streaming service API, the live streaming session streaming audio data from a first user captured via a first user device; receiving a session identifier generated by the streaming service API, the session identifier associated with the live streaming session; generating a join code associated with the session identifier; verifying the join code received from a second user via a second user device; providing the session identifier to the second user device; and transmitting the live streaming session to the second user device in response to receiving the session identifier.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 illustrates an exemplary layout of a physical computing environment including a supervisory system for dynamically adjusting data collection within the physical computing environment, according to the principles of the present disclosure.

FIG. 2 depicts a flowchart of a method for dynamically adjusting data collection within a physical computing environment, according to the principles of the present disclosure.

FIG. 3 is a block diagram of an example computing device that may be used to implement embodiments, according to the principles of the present disclosure.

Those skilled in the art will appreciate and understand that, according to common practice, various features of the drawings discussed below are not necessarily drawn to scale, and that dimensions of various features and elements of the drawings may be expanded or reduced to more clearly illustrate the embodiments of the present disclosure described herein.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The present specification and accompanying drawings disclose one or more embodiments that incorporate the features of the present disclosure. The scope of the present disclosure is not limited to the disclosed embodiments. The disclosed embodiments merely exemplify the present disclosure, and modified versions of the disclosed embodiments are also encompassed by the present disclosure. Embodiments of the present disclosure are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially,” “approximately,” and “about” modifying a condition or relationship characteristic of a feature or features of an embodiment of the disclosure, are understood to mean that the condition or characteristic is defined to be within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Embodiments disclosed herein are directed to a low latency audio streaming platform for voice communication. Embodiments disclosed are configured to provide low latency live streaming technology to provide a consistent audio listening experience for users.

Below are two explained points of views for users and a description on how the platform works. For example, a presenter may sign in and be directed to a start a stream page automatically. Before staring a stream, the stream is initialized using a streaming service Application Programming Interface (API) to create a specific session ID, also referred to as stream ID herein.

After selecting a microphone to stream from and clicking “start streaming,” a broadcasting application uses the session ID to broadcast audio a specific Uniform Resource Locator (URL). The session ID, upon successfully starting the livestream, is uploaded to a field in a “room” data structure within a real-time data management system. The room ID is the presenter's specific sign-in ID, which is randomized, has no association with personal identifiers (e.g., usernames, email etc.,), and poses minimal security risks. Finally, the room ID appears below the buttons and microphone selection, allowing the presenter to share the room ID with listeners. If the presenter wants to end the room, the presenter can click the “close room” button, which will instruct the broadcasting application to stop streaming and use the streaming service API to close that stream.

Additionally, when the listener signs in, the listener is taken to a screen with an open text box for a room ID and a button labeled “join room.” After obtaining the room code from the presenter, the web browser contacts the real-time data management system and returns the specific session ID provided by the streaming service API. This loads the session ID into the web viewer, enabling the listener to access the audio of the stream.

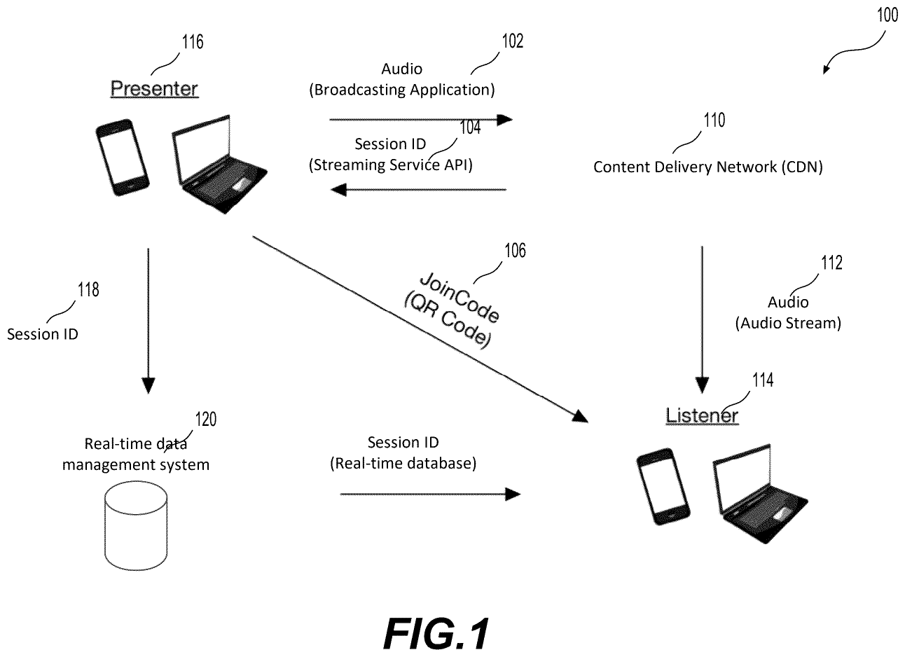

To explain the foregoing in further detail, FIG. 1 will now be described. FIG. 1 represents an exemplary embodiment of a low-latency live audio streaming system 100. For example, FIG. 1 illustrates communication between two users, a presenter and a listener, utilizing a series of connected components that include a broadcasting application, a streaming service API, a content delivery network (CDN), and a real-time data management system.

For example, in FIG. 1, a presenter 116 may initiate an audio stream using a broadcasting application 102, which may be hosted on a user device, such as a computer, smartphone, or tablet. The broadcasting application 102 runs locally on the presenter's device to capture and transmit audio data to the streaming infrastructure, including a streaming service API 104 a content delivery network 110. Upon starting the stream, the broadcasting application 102 communicates with the streaming service API 104 to establish a session, generating a session ID 118. The session ID may serve as a unique identifier for the streaming session and is subsequently stored in a real-time data management system 120 for later retrieval from a real-time database of the real-time data management system 120. The real-time data management system 120 may dynamically manage session data, such as session IDs, room identifiers, and join codes. The streaming service API may be hosted on a server in the cloud and acts as an intermediary between the user device (hosting the broadcasting application 102) and the CDN 110.

Additionally, as depicted in FIG. 1, the broadcasting application 102 generates a join code 106, which can be shared with potential listeners. The join code 106 may serve as an access credential, allowing listeners to connect to the live audio stream. The join code 106 can take various forms, such as a QR code, to facilitate access for listeners.

As further depicted in FIG. 1, a listener 114 may use the join code 106 to access the stream. The join code 106 may be validated by the real-time data management system 120, which provides the corresponding session ID 118, which is required to connect to the live audio stream, to a user device of the listener 114.

Additionally, to help further illustrate, the user device of the presenter 116 captures audio 112 through the broadcasting application 102. The broadcasting application 102 transmits the audio 112 to the streaming service API 104. The streaming service API 104 communicates with the CDN 110 to deliver the audio content to the user device of the listener 114 after receiving the session ID 118 from the user device of listener 114. The user device of the listener 114 then receives audio 112 through the CDN 110.

In some embodiments, the low-latency live audio streaming system 100 may be implemented with minimal restrictions on who can join. For example, in a university context, students and professors may sign in with their university credentials. Moreover, presenters may be limited to professors and professors may only be allowed to make rooms; whereas anyone with the join code or room code may join. In some embodiments, two-factor authentication may be implemented for additional security, allowing only authorized users (e.g., professors, students, or listeners) to join a session using the join code.

In some embodiments, the low-latency live audio streaming system 100 may include a set of files stored in the real-time data management system 120. The set of files may include fields that correlate with the session ID 118, which uniquely identifies each live streaming session. The set of files may store information needed to manage the stream, such as the session ID 118 and access data.

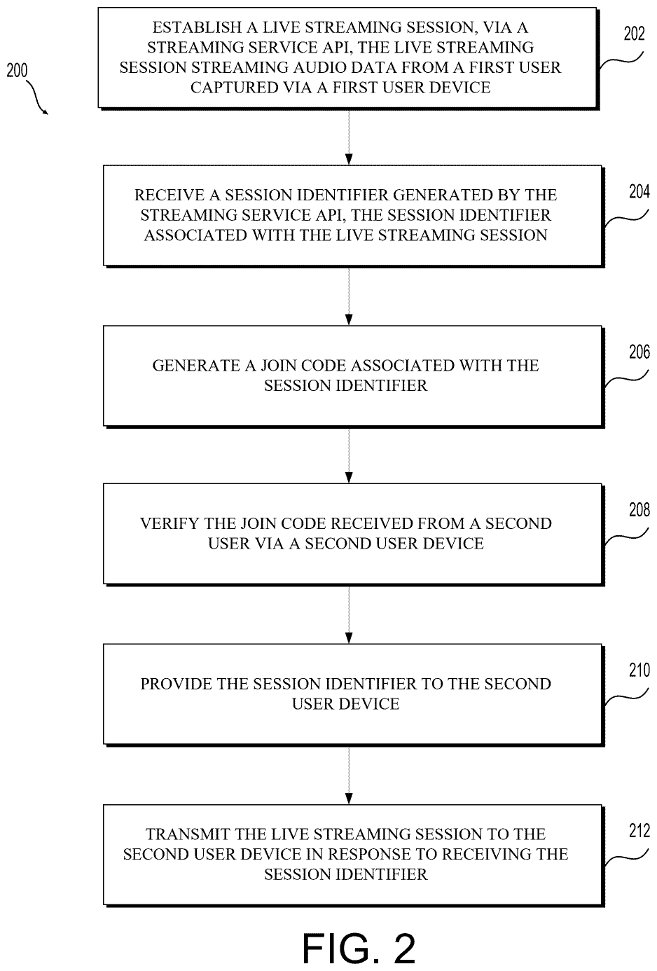

FIG. 2 depicts a flowchart 200 of a method for enabling streaming of audio, according to an example embodiment. As shown in FIG. 2, the method of flowchart 200 begins at step 202. In step 202, a live streaming session is established, via a streaming service API, the live streaming session streaming audio data from a first user captured via a first user device.

At step 204 in flowchart 200, a session identifier is received, where the session identifier is generated by the streaming service API and the session identifier is associated with the live streaming session.

At step 206 in flowchart 200, a join code associated with the session identifier is generated.

At step 208 in flowchart 200, the join code is received from a second user via a second user device.

At step 210 in flowchart 200, the session identifier is provided to the second user device.

At step 212 in flowchart 200, the live streaming session is transmitted to the second user device in response to receiving the session identifier.

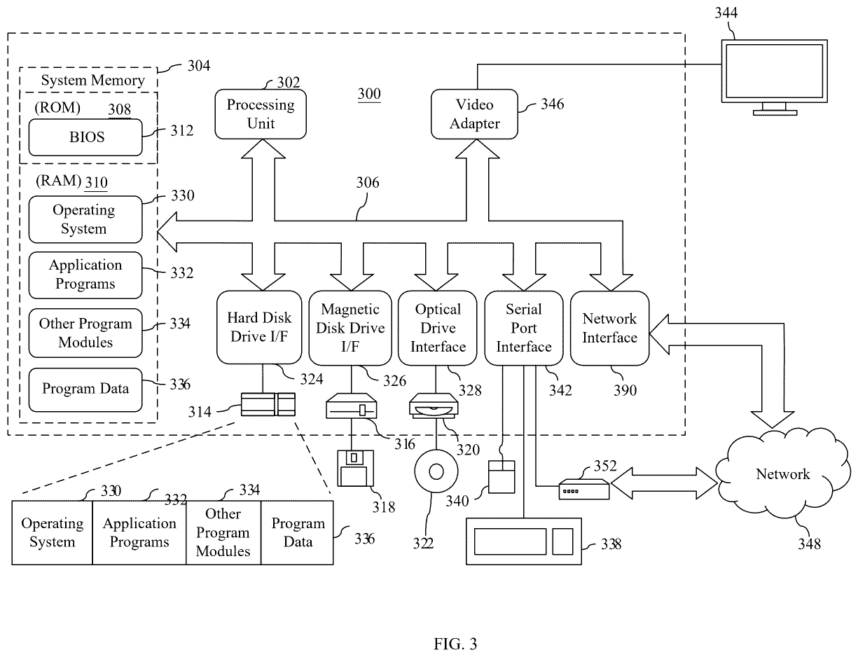

FIG. 3 depicts an example processor-based computer system 300 that may be used to implement various embodiments described herein, such as any of the embodiments described in the above and in reference to FIGS. 1 and 2. For example, processor-based computer system 500 may be used to implement any of the components of the low-latency live audio streaming system 100 as described above in reference to FIGS. 1 and 2. The description of processor-based computer system 300 provided herein is provided for purposes of illustration and is not intended to be limiting. Embodiments may be implemented in further types of computer systems, as would be known to persons skilled in the relevant art(s).

As shown in FIG. 3, processor-based computer system 300 includes one or more processors, referred to as processor circuit 302, a system memory 304, and a bus 306 that couples various system components including system memory 304 to processor circuit 302. Processor circuit 302 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 302 may execute program code stored in a computer readable medium, such as program code of operating system 330, application programs 332, other programs 334, etc. Bus 306 represents one or more of any of several types of bus structures, including a memory bus or memory controller, a peripheral bus, an accelerated graphics port, and a processor or local bus using any of a variety of bus architectures. System memory 304 includes read only memory (ROM) 308 and random access memory (RAM) 310. A basic input/output system 312 (BIOS) is stored in ROM 308.

Processor-based computer system 300 also has one or more of the following drives: a hard disk drive 314 for reading from and writing to a hard disk, a magnetic disk drive 316 for reading from or writing to a removable magnetic disk 318, and an optical disk drive 320 for reading from or writing to a removable optical disk 322 such as a CD ROM, DVD ROM, or other optical media. Hard disk drive 314, magnetic disk drive 316, and optical disk drive 320 are connected to bus 306 by a hard disk drive interface 324, a magnetic disk drive interface 326, and an optical drive interface 328, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMS, ROMs, and other hardware storage media.

A number of program modules may be stored on the hard disk, magnetic disk, optical disk, ROM, or RAM. These programs include operating system 330, one or more application programs 332, other programs 334, and program data 336. Application programs 332 or other programs 334 may include, for example, computer program logic (e.g., computer program code or instructions) for implementing the systems described above, including the embodiments described in reference to FIGS. 1 and 2.

A user may enter commands and information into processor-based computer system 300 through input devices such as keyboard 338 and pointing device 340. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 302 through a serial port interface 342 that is coupled to bus 306, but may be connected by other interfaces, such as a parallel port, game port, or a universal serial bus (USB).

A display screen 344 is also connected to bus 306 via an interface, such as a video adapter 346. Display screen 344 may be external to, or incorporated in processor-based computer system 300. Display screen 344 may display information, as well as being a user interface for receiving user commands and/or other information (e.g., by touch, finger gestures, virtual keyboard, etc.). In addition to display screen 344, processor-based computer system 300 may include other peripheral output devices (not shown) such as speakers and printers.

Processor-based computer system 300 is connected to a network 348 (e.g., the Internet) through an adaptor or network interface 350, a modem 352, or other means for establishing communications over the network. Modem 352, which may be internal or external, may be connected to bus 306 via serial port interface 342, as shown in FIG. 3, or may be connected to bus 306 using another interface type, including a parallel interface.

As used herein, the terms “computer program medium,” “computer-readable medium,” and “computer-readable storage medium” are used to generally refer to physical hardware media such as the hard disk associated with hard disk drive 314, removable magnetic disk 318, removable optical disk 322, other physical hardware media such as RAMs, ROMs, flash memory cards, digital video disks, zip disks, MEMs, nanotechnology-based storage devices, and further types of physical/tangible hardware storage media (including system memory 304 of FIG. 3). Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 332 and other programs 334) may be stored on the hard disk, magnetic disk, optical disk, ROM, RAM, or other hardware storage medium. Such computer programs may also be received via network interface 350, serial port interface 342, or any other interface type. Such computer programs, when executed or loaded by an application, enable processor-based computer system 300 to implement features of embodiments discussed herein. Accordingly, such computer programs represent controllers of processor-based computer system 300.

In some embodiments, a method for enabling streaming of a live audio feed includes: establishing a live streaming session, via a streaming service application programming interface (API), the live streaming session streaming audio data from a first user captured via a first user device in communication with a server computing device configured to host the live streaming session, wherein the server computing device is connected to a local area network associated with the first user device; receiving a session identifier generated by the API; generating a join code associated with the session identifier; verifying the join code received from a second user via a second user device; providing the session identifier to the second user device; and transmitting the live streaming session to the second user device in response to receiving the session identifier, wherein the second user device is connected to the local area network.

In some embodiments, the session identifier is uniquely associated with the live streaming session. In some embodiments, the first user device and the second user device are co-located. In some embodiments, the server computing device is configured to communicate with the first user device and the second user device via the API. In some embodiments, the first user device is configured to execute audio transcription software. In some embodiments, the first user device, executing the audio transcription software, transcribes audio received at an audio receiver associated with the first user device, in real-time.

In some embodiments, a system for enabling streaming of a live audio feed includes: a server computing device configured to host a live streaming session via a local area network and to execute a streaming service application programming interface (API) configured to: establish a live streaming session, via the API, the live streaming session streaming audio data from a first user captured via a first user device in communication with the server computing device via the a local area network associated with the first user device; receive a session identifier generated by the streaming service API; generate a join code associated with the session identifier; verify the join code received from a second user via a second user device; provide the session identifier to the second user device; and transmit the live streaming session to the second user device in response to receiving the session identifier, wherein the second user device is connected to the local area network.

In some embodiments, the session identifier is uniquely associated with the live streaming session. In some embodiments, the first user device and the second user device are co-located. In some embodiments, the server computing device is configured to communicate with the first user device and the second user device via the API. In some embodiments, the first user device is configured to execute audio transcription software. In some embodiments, the first user device, executing the audio transcription software, transcribes audio received at an audio receiver associated with the first user device, in real-time.

In some embodiments, an apparatus includes: a processor; and a memory including instructions that, when executed by the processor, cause the processor to: generate, using a local area network, a live streaming session configured to transmit streaming audio data from captured via a microphone on a first user device situated in a first location of a presentation facility and in communication with the local area network; receive a session identifier generated by a streaming service application programming interface (API); generate a join code associated with the session identifier; verify the join code received from a second user device situated in a second location in the presentation facility; provide the session identifier, via the local area network, to the second user device; and transmit, via the local area network, the live streaming session to the second user device in response to receiving the session identifier.

In some embodiments, the session identifier is uniquely associated with the live streaming session. In some embodiments, the first user device and the second user device are co-located. In some embodiments, the instructions further cause the processor to communicate with the first user device and the second user device via the API. In some embodiments, the first user device is configured to execute audio transcription software. In some embodiments, the first user device, executing the audio transcription software, transcribes audio received at an audio receiver associated with the first user device, in real-time. In some embodiments, a recording of the live streaming session is stored via the local area network. In some embodiments, the audio data includes lecture data presented live to a classroom comprising at least one student, wherein the at least one student is associated with the second user device.

In some embodiments, the session identifier may be generated by a location specific identity verification software or program. For example, the systems and methods described herein may be implemented at a university campus (e.g., or other suitable location). The university campus may utilize a location specific identity verification program that verifies the identity of students permitted on campus and/or in a specific classroom during a specific period (e.g., for a specific class taught by a specific professor). The location specific identify verification program may generate the session identifier and grant access to the session identifier based on the verification of, for example, a student intending to stream the live lecture in a specific class during a specific period. Additionally, or alternatively, the first user device, or the server computing device may generate the session identifier, and the location specific identity verification program may verify the identity of the, for example, second user (e.g., the student).

In some embodiments, the systems and methods described herein may be configured to create a lecture as a logged in user. In some embodiments, the systems and methods described herein may be configured to allow a user to join a lecture as an anonymous public user. In some embodiments, the systems and methods described herein may be configured to provide relatively easy joining procedures using a human-readable friendly ID and QR code. In some embodiments, the systems and methods described herein may be configured to provide low latency WebRTC audio streaming. In some embodiments, the systems and methods described herein may be configured to provide live speech transcription (e.g., using Deepgram or other suitable transcription mechanism).

In some embodiments, the systems and methods described herein may be configured to provide an auto-generated summary in response to the conclusion of the lecture (e.g., in response to the first user ending the streaming session). In some embodiments, the systems and methods described herein may be configured to provide full localization in multiple languages. In some embodiments, the systems and methods described herein may be configured to provide a mobile-friendly responsive design.

In some embodiments, the systems and methods described herein may be configured to use one or more API keys, such as an API key for transcription and/or an API key for large language model summaries. In some embodiments, the systems and methods described herein may be configured to use ffmpeg libraries for decoding audio (e.g., using: Docker to containerize everything; Elixir and/or Erlang to run the backend; Mix, Hex, and Rebar to generate the system; Node.js for compiling frontend assets; Debian Linux system tool, and/or any suitable tools, software programs, and the like).

Implementations of the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A method for enabling streaming of a live audio feed, the method comprising:
establishing a live streaming session, via a streaming service application programming interface (API), the live streaming session streaming audio data from a first user captured via a first user device in communication with a server computing device configured to host the live streaming session, wherein the server computing device is connected to a local area network associated with the first user device;
receiving a session identifier generated by the API;
generating a join code associated with the session identifier;
verifying the join code received from a second user via a second user device;
providing the session identifier to the second user device; and
transmitting the live streaming session to the second user device in response to receiving the session identifier, wherein the second user device is connected to the local area network.

2. The method of claim 1, wherein the session identifier is uniquely associated with the live streaming session.

3. The method of claim 1, wherein the first user device and the second user device are co-located.

4. The method of claim 1, wherein the server computing device is configured to communicate with the first user device and the second user device via the API.

5. The method of claim 1, wherein the first user device is configured to execute audio transcription software.

6. The method of claim 5, wherein the first user device, executing the audio transcription software, transcribes audio received at an audio receiver associated with the first user device, in real-time.

7. A system for enabling streaming of a live audio feed, the system comprising:
a server computing device configured to host a live streaming session via a local area network and to execute a streaming service application programming interface (API) configured to:
establish a live streaming session, via the API, the live streaming session streaming audio data from a first user captured via a first user device in communication with the server computing device via the a local area network associated with the first user device;
receive a session identifier generated by the streaming service API;
generate a join code associated with the session identifier;
verify the join code received from a second user via a second user device;
provide the session identifier to the second user device; and
transmit the live streaming session to the second user device in response to receiving the session identifier, wherein the second user device is connected to the local area network.

8. The system of claim 7, wherein the session identifier is uniquely associated with the live streaming session.

9. The system of claim 7, wherein the first user device and the second user device are co-located.

10. The system of claim 7, wherein the server computing device is configured to communicate with the first user device and the second user device via the API.

11. The system of claim 7, wherein the first user device is configured to execute audio transcription software.

12. The system of claim 11, wherein the first user device, executing the audio transcription software, transcribes audio received at an audio receiver associated with the first user device, in real-time.

13. An apparatus comprising:
a processor; and
a memory including instructions that, when executed by the processor, cause the processor to:
generate, using a local area network, a live streaming session configured to transmit streaming audio data from captured via a microphone on a first user device situated in a first location of a presentation facility and in communication with the local area network;
receive a session identifier generated by a streaming service application programming interface (API);
generate a join code associated with the session identifier;
verify the join code received from a second user device situated in a second location in the presentation facility;
provide the session identifier, via the local area network, to the second user device; and
transmit, via the local area network, the live streaming session to the second user device in response to receiving the session identifier.

14. The apparatus of claim 13, wherein the session identifier is uniquely associated with the live streaming session.

15. The apparatus of claim 13, wherein the first user device and the second user device are co-located.

16. The apparatus of claim 13, wherein the instructions further cause the processor to communicate with the first user device and the second user device via the API.

17. The apparatus of claim 13, wherein the first user device is configured to execute audio transcription software.

18. The apparatus of claim 17, wherein the first user device, executing the audio transcription software, transcribes audio received at an audio receiver associated with the first user device, in real-time.

19. The apparatus of claim 13, wherein a recording of the live streaming session is stored via the local area network.

20. The apparatus of claim 14, wherein the audio data includes lecture data presented live to a classroom comprising at least one student, wherein the at least one student is associated with the second user device.
